(19) United States
(12) Patent Application Publication
(10) Pub. No.: US 2018/0051509 A1
(43) Pub. Date: Feb. 22, 2018

(54) SMART DOOR SYSTEM AND METHOD OF USE

(71) Applicant: Darwin German, Argyle, TX (US)

(72) Inventor: Darwin German, Argyle, TX (US)

(21) Appl. No.: 15/683,518

(22) Filed: Aug. 22, 2017

Related U.S. Application Data
(60) Provisional application No. 62/377,729, filed on Aug. 22, 2016.

(51) Int. Cl. E06B 5/10; E05B 47/00; E05C 9/00; E06B 7/28; E06B 5/18

(52) U.S. Cl. CPC E06B 5/10; E05B 47/0001; E05B 2047/0068; E06B 7/28; E06B 5/18; E05C 9/00

(57) ABSTRACT

A smart door includes a frame having a front surface and an opposing a back surface; a first display on the front surface; a second display on the back surface; a camera positioned on the front surface and in data communication with the second display; and a plurality of slide bolts configured to lock the frame in a fixed position with a surrounding structure.

### BACKGROUND

### 1. Field of the Invention

The present invention relates generally to doors, and more specifically, to a smart door and method of use.

### 2. Description of Related Art

Doors for providing entrance into a room are well known in the art and are effective means for protection. For example, in FIG. 1 an exemplary conventional system 101 includes a building 103 with a door 105 that provides a person 109 entrance into the room disposed within building 103. One the problems associated with building 103 is that no windows are provided and the party within the room has no means to visually identify the party 109.

One method to overcome this problem is to utilize a hole 107 extending through the door, which in turn provides viewing access to the parties standing outside the door. However, the hole 107 has limitations. For example, the hole may not capture a wide enough viewing area to see the party 109 and/or the party 109 may simply cover the hold with a finger.

Accordingly, although great strides have been made in the area of doors and methods for protection, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a conventional door;

FIG. 2 is a front view of a smart door system and method of use in accordance with one embodiment of the present application during operation;

FIG. 3 is a back view of the smart door system of FIG. 2;

FIG. 4 is a schematic of the smart door system in accordance with an alternative embodiment; and

FIG. 5 is a schematic of the control assembly of the smart door system of FIG. 2.

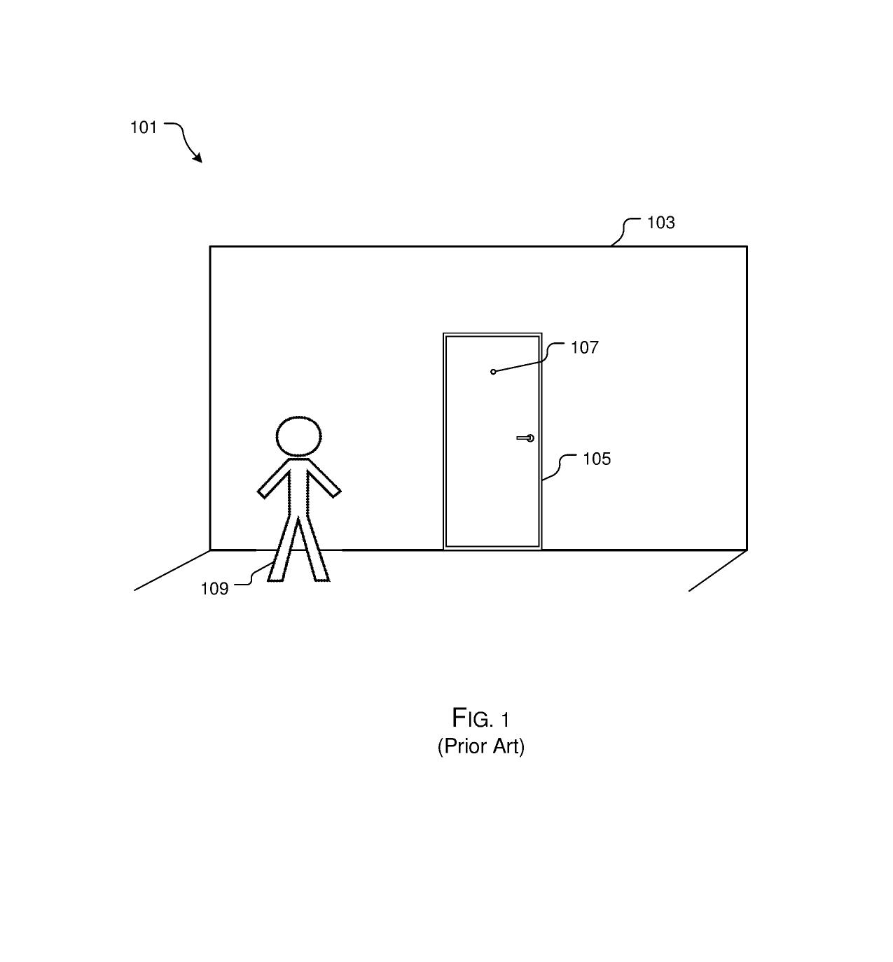

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

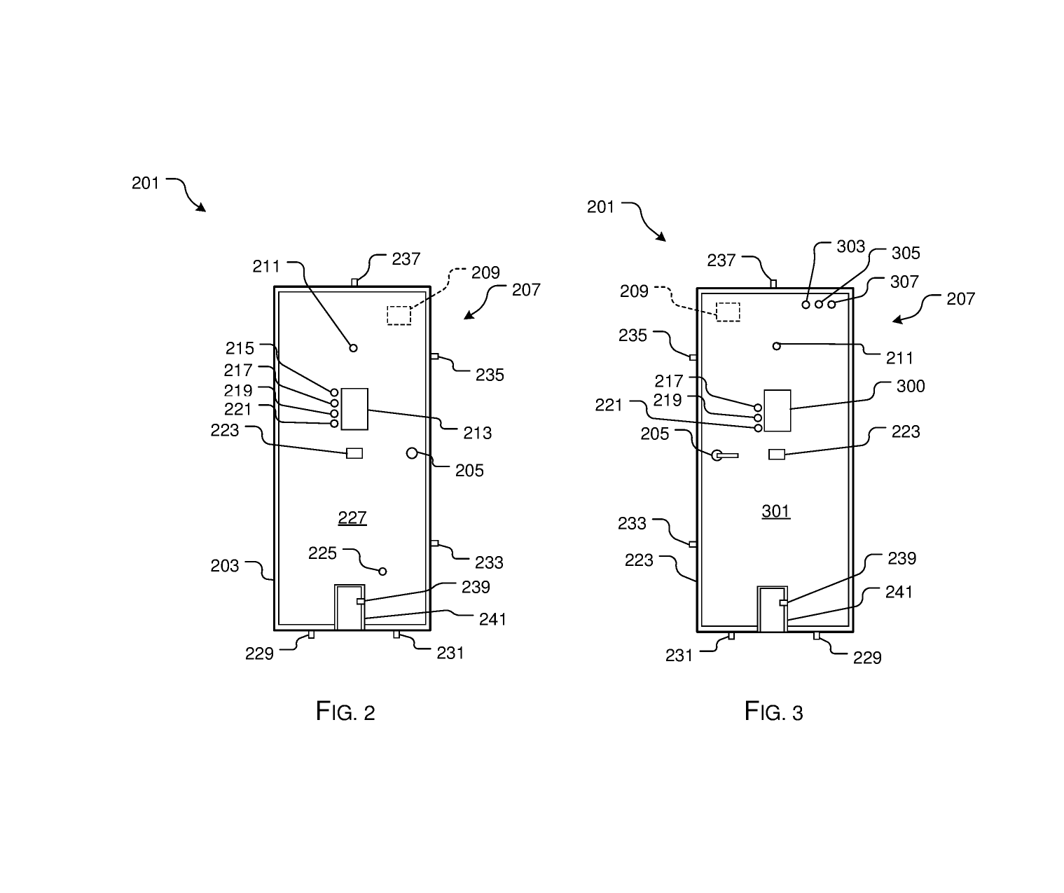

Referring now to the drawings wherein like reference characters identify corresponding or similar elements throughout the several views, FIGS. 2-5 depict various views of a smart door system 201 in accordance with a preferred embodiment of the present invention. It will be appreciated that system 201 overcomes one or more of the above-listed problems commonly associated with the conventional doors.

In the contemplated embodiment, system 201 includes one or more of door frame 203 having a door knob 205 and a control assembly 207. In the preferred embodiment, the control assembly 207 is configured to protect the party within the room for potential treat created by dangerous third parties 109, fire, and/or other dangerous events. For example, the system 201 could be utilized at a school wherein all doors to the classroom are closed and secured to prevent a shooter from entering into the classrooms. It will be appreciated that a plurality of applicable uses for system 201 are contemplated with the features discussed herein.

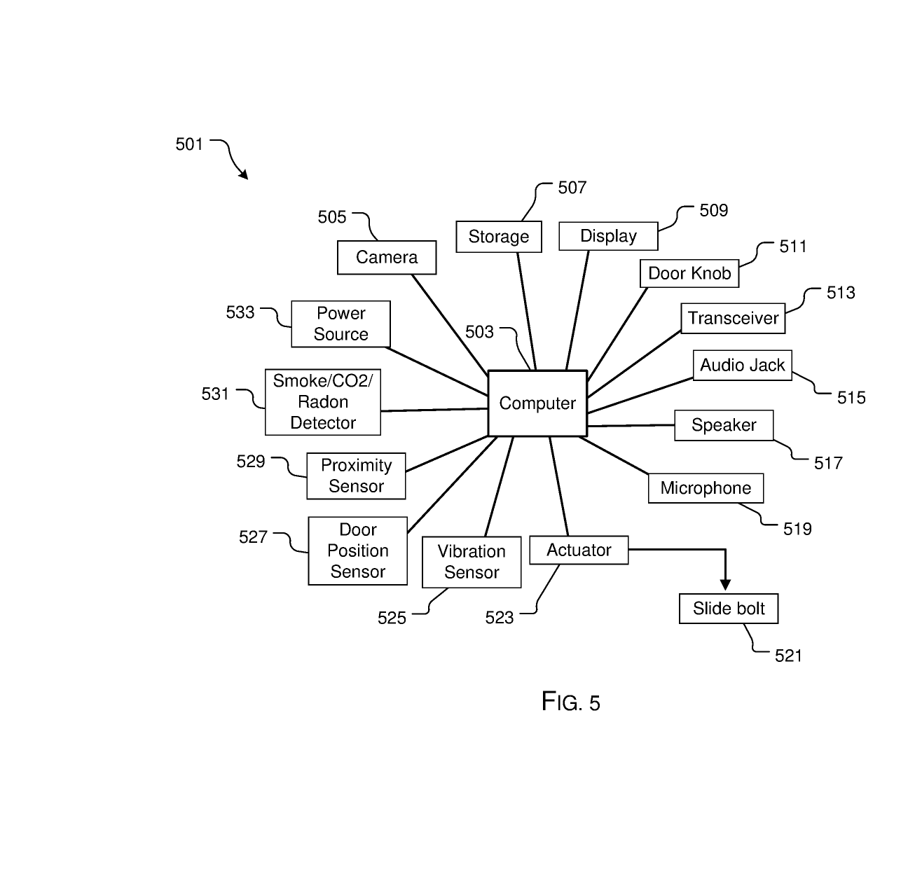

Control assembly 207 includes a computer 209 preferably disposed within the door and operably associated with one or more devices of system 201. System 201 includes a camera 211, a display 213, one or more devices 215, 217, 219, 211, 223, and 225 extending from a front surface 227. The different types of devices are further discussed below with reference to FIG. 5.

In one preferred embodiment, the system 201 is provided with a plurality of slide bolts 229, 231, 233, 235, and 237 positioned around the periphery of the door and configured to slidingly engage with an opening disposed within the thickness of the door. An actuator disposed within the door could be utilized to actuate the slid bolts. In one embodiment, the system 201 could include a dog door 241 also having a slide bolt 239 associated therewith. In the exemplary embodiment, a second display 300 is secured to surface 301 of the door frame and in data communication with the display 213 on the opposing side of the door frame. The system 201 is further provided with one or more devices 303, 305, and/or 307 that provide the party within the room one or more visual indicators. For example, a light may be lit if the presence of a fire is at the opposing side of the door frame.

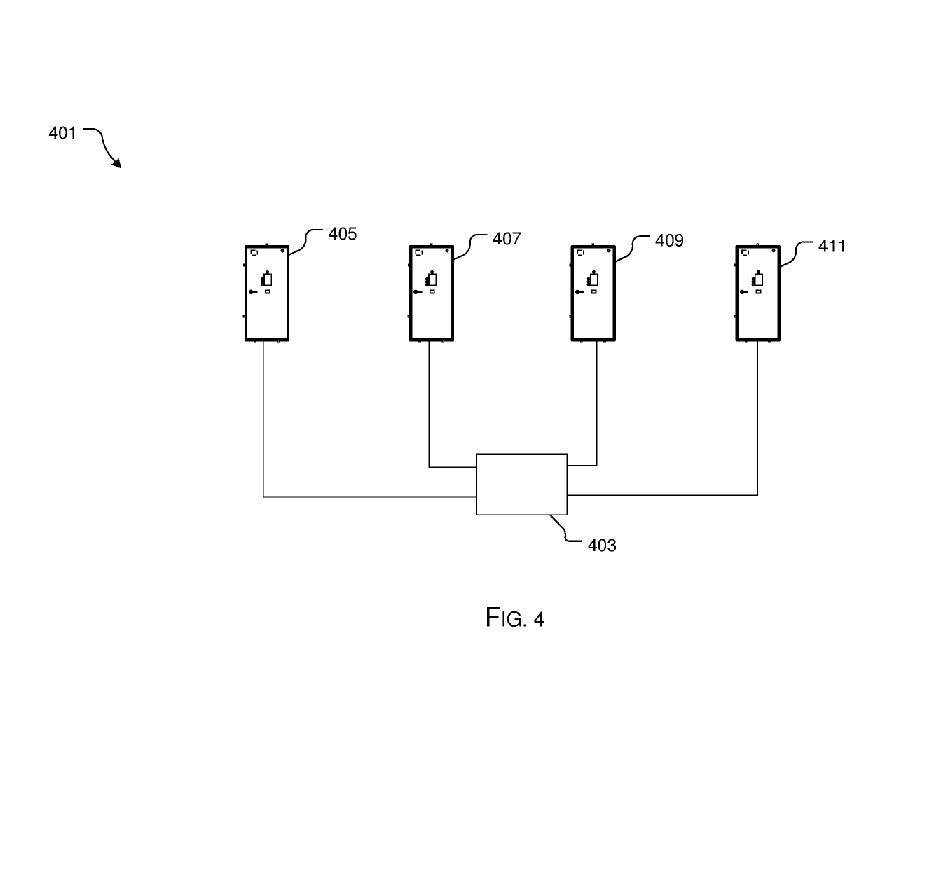

In FIG. 4, a system 401 is shown utilizing the features of system 201 with a plurality of doors 405, 407, 409, and 411 in data communication with and manipulated by a control computer 403. For example, the control computer 403 could close all doors in the event of an emergency and monitor third party activities via one or more devices associated with each door. In one embodiment, a control station, e.g., a police station, security, and the like, could be used to monitor activity proximate to the door 203 via the control system and manipulate use of the door.

In FIG. 5, a simplified schematic of the control assembly 501 is shown in accordance with one preferred embodiment of the present invention. It will be appreciated that the control assembly 207 discussed above could include one or more of the features of control assembly 501.

In the preferred embodiment, one or more devices of control assembly 501 are disposed within the door frame 203 of system 201 and/or secured to an outside surface. In the contemplated embodiment, the features of control assembly 501 are utilized in control assembly 207. For example, the device 215, 217, 219, 221 could be respective camera 505, transceiver 513, speaker 517, smoke/CO2/Radon detector 531 and/or other devices shown and described in FIG. 5.

The assembly 501 includes a computer 503 in data communication with one or more of a camera 505, storage device 507, a display 509, door knob 511, transceiver 513, audio jack 515, speaker 517, microphone 519, actuator 523 that in turn is operably associated with one or more slide bolts 521, a vibration sensor 525, a door position sensor 527, a proximity sensor 529, a smoke/CO2/Radon detector 531, and/or a power source 533.

In one embodiment, the computer 503 includes the necessary software and hardware to control one or more devices operably associated therewith. The computer 503 could be configured to communicate with a central computer 403 discussed above.

The camera 505 could include a close-up camera and/or a wide-angle camera and is positioned on surface 227 and/or disposed within the thickness of door 203. The camera 505 could be displayed on display 509 and/or transmitted to an external display (not shown) via transceiver 513.

It will be appreciated that the devices associated with assembly 501 could be collect data and store the data within a storage, e.g., a flash memory stick, internal storage, and the like, for later retrieval. For example, picture identity of the third party 109 standing outside the door could be later retrieved for capture.

A display 509 could include the option of merely displaying information associated with the system and could include a finger touch option for manual manipulations. As shown in FIGS. 2 and 3, it is contemplated having two touch screens 213, 300 in data communication with each other and/or manipulated separately. For example, the party 109 could attempt to communicate with the party within the room via the touch screen.

The transceiver 513 could be utilized to communicate with a central computer 403 and/or other remote computer system. The transceiver could include wireless features for communication networks such as WiFi, BLUETOOTH, cellular, and the like. The assembly is further provided with an audio jack 515, speaker 517, and a microphone 519 for communicating with the party 109.

As depicted in FIGS. 2 and 3, a plurality of slide bolts are positioned around the periphery of the door frame. One or more actuators 523 in data communication with the computer 503 could be utilized to secure the door in a locked position.

The assembly is also provided with a plurality of sensors and detectors such as a smoke/CO2/Radon detector 531, a motion or proximity sensor 529 for detecting movement, and a door position sensor 527 to determine if the door is ajar or closed.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variationDars are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A smart door, comprising:
a frame having a front surface and an opposing a back surface;
a first display on the front surface;
a second display on the back surface;
a camera positioned on the front surface and in data communication with the second display; and
a plurality of slide bolts configured to lock the frame in a fixed position with a surrounding structure;
wherein the plurality of slide bolts are controlled via the second display.

2. The smart door of claim 1, further comprising:
a transceiver on the front surface and in data communication with the second display.

3. The smart door of claim 1, further comprising:
a smoke/CO2/Radon detector secured to the front surface and in data communication with the second display.
